(19) United States
(12) Patent Application Publication
(10) Pub. No.: US 2004/0080411 A1
(43) Pub. Date: Apr. 29, 2004

(54) Continuous security system

(76) Inventor: William Leonard Renfro, Washington, DC (US)

Correspondence Address: William L. Renfro, 1431 Thirty Third St NW, Washington, DC, 20007, US

(21) Appl. No.: 10/282,300

(22) Filed: Oct. 29, 2002

(51) Int. Cl. G08B 1/08

(52) U.S. Cl. 340/539.1; 340/573.1; 701/1; 244/75 R; 340/5.2; 340/5.82

(57) ABSTRACT

This invention includes a tamper-proof security system to assure the use of, control of and access to the controls of technological systems is, at all times and on a continuous basis, limited exclusively to authorized personnel. This security system includes applications to technological equipment available to, responding to, requiring or involving human participation for their operation and control such as weapons, power plants, machines, communication systems, computer systems, pipeline controls, control centers and transportation equipment including ships, trains, aircraft, trucks and cars. This tamper-proof security system can also be used to limit to authorized persons only, the physical entry into and continued access to restricted areas as well as continuing access to information, data processing, storage and communications systems. In addition, this security system can be used to provide tamper-proof security where the authorized personnel are known or selected from a known group.

### BACKGROUND OF THE INVENTION

The security of the control of technological equipment is an increasingly important issue. Regardless of the security systems employed to screen passengers and crew of airplanes and other means of public transportation, for example, transportation and other mobile equipment remain vulnerable to being diverted from their designed, intended or planned uses by unauthorized personnel. As long as the ultimate control of aircraft, of equipment, weapons, transportation units or other mobile equipment remains on-board, with the system or at control points of the system, this risk of unauthorized use remains an issue. The current invention addresses this issue by providing a continuous, fail-safe security system that cannot be tampered with or altered from on-board the craft, in the control room or at the point of control of a technological system so that with this security system in operation, a technological system cannot be diverted from its authorized use or course by unauthorized personnel. This invention also addresses the physical security of command and control points of technological equipment.

Security of technological equipment relies on the use of some means or key to restrict access to the systems to those persons in possession of the key. Some keys are mechanical; some are electric; some magnetic; some use code numbers; others use audio keys typed into a keyboard. A limit to the security that can be provided by all systems involving a key of any kind is the security of the key itself—i.e., access to the secured system is provided to persons possessing the key. While keys with thousands, millions, billions or, with modern cryptographic algorithms, an infinite number of possible unique keys can be designed so that by trial and error alone, no one can, in a reasonable period of time, obtain the key, any person, however, in possession of the key, code or audio key can obtain access to the secured technological system. In recent years, keys based on personal characteristics—so-called biometric keys—that cannot be duplicated by another person have been developed. These include finger print systems, retina-scan systems and DNA sampling systems, among others. These have addressed some of the vulnerabilities of the security of systems, but not all of them. Once a biometric key has been provided by an authorized operator, the operator can be replaced by unauthorized personnel or can be forced to follow directions of unauthorized personnel.

While these biometric keys offer generally a higher level of security than traditional, impersonal keys, they are not tamper-proof. Unauthorized access can be obtained by a copy of a persons finger print or by using the authorized person's finger itself. Copies of retina scans can be made and used, as well as the actual retina. And of course, personal DNA is readily available without amputation, decapitation or other physical harm to the authorized persons—since we all leave a nearly continuous trail of our DNA in skin cells shed as we move about, samples of an authorized person's DNA can be obtained without the person's even knowing it was taken.

One personal key that cannot be used by anyone other than the authorized person is a voice recognition “audio key” based on the voice of the authorized person speaking a specific word or phrase. Wile other persons may obtain the key or audio key, this is of no value as voice recognition systems use not only the specific word or phrase spoken, but they also use the specific voice with its unique combination of resonances, tones, overtones, harmonics, timing and inflections in determining whether a proffered audio key or audio key is genuine. Even a recording of the authorized voice stating the correct audio key cannot fool modern voice recognition technology. By requiring frequently, daily, or for each new period of access to the controls of equipment or a system, the generation a new, previously established audio key, voice audio key or phrase of the authorized personnel, even the opportunity to make a copy of a person's audio key is eliminated. These new keys can be as simple as reciting into the security system the date of the use of the system. This invention uses voice recognition technology in a system that couples a secure input point for generation of an audio key where this input point is or subsequently will be physically separate from control points of the system being secured, with a means at the point of control of secured system of requiring the audio key for initial and continued access to control of the secured system. This initial and periodic authorization point is located at the control point of the secured system such as a pilot house or cockpit.

For security of transportation systems such as aircraft, the input point for the audio key may be established in pre-flight ready rooms which are only accessible to licensed pilots, with the audio key subsequently being required of the pilots by the on-board portion of the security system for initial and continuous control of the aircraft. For security of stationary systems, these two points may be an operator check-in facility and the control room. For mobile or portable equipment such as vehicles or weapons, the input point is the location of an immobile input device to which the equipment being secured must be attached when the audio key is generated. Once the audio key has been generated at the input point and installed in the secured system control point, the installed audio cannot be changed unless the mobile equipment is reattached to the immobile input device.

This invention is useful in all cases where access to and continuing control over equipment, systems, or devices is required. For example, in an automobile, the voice key is input into the control system of the car at an authorized place such as a car dealership via unique equipment located there. In the alternative, a portable mechanism provided to the owner or authorized user can be used to set or re-set the security system on the car. This mechanism could be designed, for example, to be attached to the car under the hood so that it could not be closed with the input mechanism attached, encouraging the owner not to keep it with or carry it on-board the car.

The security system allows the authorized user to input a series of audio keys to meet a variety of circumstances, each directing the security system to invoke different responses or protocols. These protocols might include, when applied to security for a car, various limited authorizations such as are needed for repair stations, garages, parking services, among others times when range of the car is intended to be limited. Another protocol might limit the maximum speed, operating time or distance, RPM of the engine or use of other capabilities, features, equipment, capacities or spaces of the vehicle. Protocols might provide for emergencies such as a high-jacking attempt, providing pre-configured responses such as slowly reducing engine RPM's to idle, applying breaking systems, limiting or eliminating access to fuel supplies, flashing external lights or alerting authorities via cell phone or other systems such as Cadillac's North Star, among others.

Another example of the use of this invention applies to weapons and weapon systems, including portable weapons. Two important issues of weapons' security are unauthorized access to weapon systems not in use and access to weapon systems obtained from authorized users such as those captured in combat and which can then be turned against the authorized users or others. The system protocols for weapon systems, for example, are set to require reauthorization before stored weapons and weapon systems can be operated. For weapons and weapons systems in use, continued control over the weapons or the weapon systems, including use of the them, requires, for example, reauthorization at set or random intervals of time, upon receipt of an on-demand reauthorization signal from external authorities, after a specified amount of transport, after specific motions or specific events such a set number of uses of the weapon, changing any of the user-controlled parameters of the weapon or weapon system, loss of physical contact between the weapon and the authorized user, among others.

In addition to preventing unauthorized access to weapons, protocols may be set to take more aggressive actions such as disabling key components so that even with the authorizing key, the weapon or weapon system will remain inoperable until other previously established criteria are met such as replacement of the disabled component or receipt of a re-set signal sent from personnel controlling equipment generating the now-disabled audio key. With this protocol protection, an authorized user could not be forced to provide authorization if he or she had invoked the disabling protocol. Even more aggressively in extreme circumstances, the protocols may be set to follow a variety of procedures designed to disabling attacks on unauthorized personnel attempting to use the weapon or weapon system, ranging from administering shocks, detonating flash-bang devices, releasing sleep gases, among other lethal and non-lethal means.

All of the various protocols provide for various levels of reporting to the enabling authorities various parameters of the security system as well as the system being secured such as the status, operational mode, disabled components, condition and use of the systems, including attempted unauthorized uses.

### SUMMARY OF THE INVENTION

For the discussion that follows, the example of a hypothetical check-in station and control point which is operating a secured system will be used, but the idea of the invention with obvious adaptations to the different equipment, systems and technologies to be secured, also applies to ships, trains, trucks, buses, stationary or mobile power plants, information, communication and data processing, storage control systems and other systems which are or can be subject to human control that could be the target of unauthorized use, control, misdirection or sabotage. This also applies to individual weapons systems such as the Land Warrior system or the new two-barreled rifle called the Objective Individual Combat Weapon carried by US Special Forces, stun and disabling non-lethal weapons, shoulder-mounted weapons such as lasers, beam weapons, particle weapons, Light Anti-tank Weapons, surface-to-air missiles, night vision systems, GPS, navigation and communications systems, among other weapons which an individual personnel might use in law enforcement or carry into combat and which might be captured by the enemy soldiers and used to their advantage.

This invention includes elements of voice recognition technology coupled with control systems of the secure system. This security system uses oral audio keys selected and spoken by the authorized operators of the system prior to actually assuming control of the secured technological systems. These audio keys provided by the authorized operators are required by this security system to be re-entered at frequent, random intervals as a continuing requirement for control of the system to remain in their hands. With this security system, prior to entering the control room, at the check-in facility, operations room or other secure place, the authorized operators speak into a module of the security system which remains in the secured place, audio keys which they each create separately and are known only to each of them, not even to each other, into a voice recognition system which transmits or delivers the information to a module of the security system which is in the command and control room of secured system or on-board the secured system. The repetition of these audio keys, by the persons who created them, on demand by the protocols of security system are required for the continued operation of and control of the secured system. Other biometrics can be used with the key idea being the periodic provision by the previously authorized user of the authorizing key—voiced audio key, finger print, eye-scan, retina and iris scan, among others.

This security system is designed to demand the repetition of the authorizing audio key or words by the operators at random intervals and when specific events occur such as unlocking or opening the control room door, or when specific changes in the operation of controls of the system are made, such as engaging or disengaging the automatic control systems, changing power settings, changing operating parameters, changing specific controls or any of the controls, among others. The system also provides means for the operators to prompt the system to demand the audio key or conduct the audio key verification check and thus invoke the protections of the security system without having to wait to be queried.

Prior to each use of the command and control facility or expected use of the secured weapons system, each authorized person creates and speaks into the voice recognition security system, two or more audio keys. In response to a prompt from the security system such as an audio signal sent through the headphones to the authorized persons, such as a beep or designated tone, one of the authorized personnel will have to provide, within a set period of time such as 5 seconds, the audio key he or she has put into the system earlier to be used as an “all-clear” signal. If the authorized personnel responds with the second audio key provided earlier or another person attempts to provide the audio key, the security system immediately blocks input from the previously authorized personnel, transferring control of the secured system to remote operators or emergency personnel. Additional automatic responses can be configured into the security system as indicated. For example, on a ship or train, the power systems may be slowed or shut down, rudders locked, anchors or brakes deployed or other similar appropriate actions designed to block unauthorized operators.

The controls remain disabled until criteria are satisfied according to the previously established protocols such as remote control is engaged to direct and control the system or remote controllers provide a re-set signal to the security system indicating that the remote controllers are satisfied that the emergency use has ended, that the disturbance, attack or unauthorized attempted access or use has been repelled and that authorized operators are free to control the system as authorized and that the security system has also received and accepted the correct “all-clear” audio key by one or more of the authorized on-board operators.

Since the required audio keys are generated just before the authorized personnel take control of the secured equipment and are known only to their authors, no one else in or out the command and control room will have anyway to discover the audio keys. Even if another person gains knowledge of the audio key, the voice recognition technology prevents any one other than the author of the audio key from satisfying the requirement of the security system. Moreover, the second and other audio keys allow authorized personnel to invoke additional protocols which, for example, may be set to send secret messages through the security system to the authorities on the outside, of a threat, attempted takeover or other emergency as well as the type of emergency—a hijacking, intruder or other emergencies, and that the control of the system is being transferred to automatic or remote operators. Since the meaning of the audio keys is known only to their authors, no one would be able to detect whether an operator is sending a regular, periodically required audio key, an “all-clear” or one of the other or emergency audio keys. Incidents of accidental transmission of any audio key, especially emergency keys, can be reduced by setting the protocols to require repetition of a single key or transmission of more than one key to invoke emergency responses. Similarly, non-emergency keys where time and circumstances permit can be set to require a positive response to a prompt question, such as “Did you say (audio key)?”

The security system can also be directed by specific protocols to transmit alerts to remote authorities or emergency controllers as well as signals engaging information storage systems such as VCRs and hard drives, recorders of selected information from the control room sensors and monitors such as voice recorders, “black-box” information and parameters from other systems, microphones, cameras as may be available or required.

While the audio keys selected by the operators can be any word, phrase or sound they may want to use, to avoid any possible confusion, they are instructed to avoid words, numbers, names and language used even infrequently in normal internal or external communications of the system they are controlling, and to select as audio keys sounds, a combinations of letters, words from languages other than English, the international standard for many international transportation and communication systems, names of persons or things that are not used in any normal communications which are monitored or may be intercepted by the security system, including those between the remote authorities and on-board operators at the control point.

In an extended system, the security system includes the use of similarly established audio keys or keys used by guards, security or other authorized personnel outside both the security command center and control room to alert the personnel in both places of an emergency in any other area outside the command and control room and beyond the immediate purview or scrutiny of authorizing personnel as well as authorized operators. When the security system identifies a word or words spoken by outside personnel as an emergency audio key, the system's emergency protocols are invoked. These protocols, for example, notify the operators in the command and control room as well as remote, emergency operators. The system also checks and secures the locks and security of all doors, windows and means of access to the command center and control room, following additional protocols if access to the site is not secure or cannot be secured.

If at any time the systems being secured are unable to receive the output from the security system, the systems being secured are configured to initiate its own emergency protocols such as limiting controls, shutting down operations, providing notice to authorized and authorizing personnel or other appropriate actions.

### BRIEF DESCRIPTION OF THE DRAWINGS

In the figures:

FIG. 1 shows a schematic of the security system.

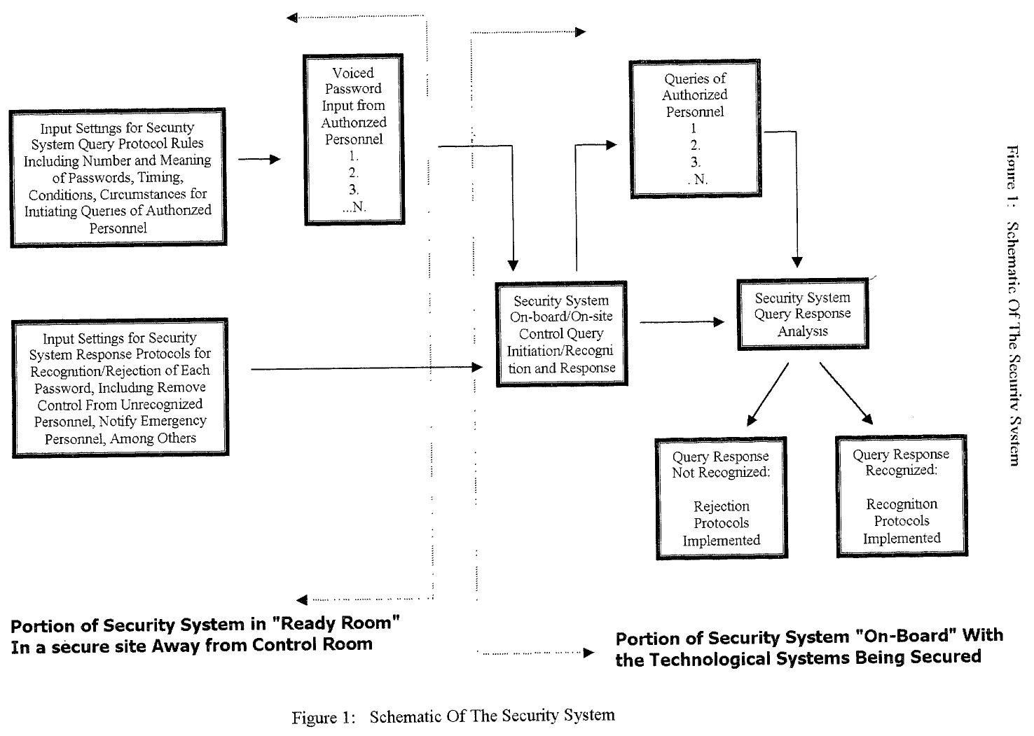

### DETAILED DESCRIPTION OF THE INVENTION

This security system provides continuing security for the operation of secured equipment using audio keys provided by authorized operators and who are periodically reauthorized to continue operating the secured equipment. This security system, comprising two separate parts, has a first part installed at an input station which is controlled by authorized personnel. These authorized personnel direct the generation of audio keys input to the system by personnel who will subsequently be operating, using or requiring access to the secured system. These audio keys generated at the first part of the system located in the input station are communicated via closed communications to the second part of the system located on-site at a control point of the secured stationary systems or on-board the secured equipment for mobile systems. This second part of the system requires periodic scheduled or random re-confirmation of the voice key by the person who generated it for that person to maintain access to and control over the secured system. In addition, the on-site/on-board part is designed to query the operators of the secured system for the voice key when specific events occur which are involved in or related to the continued operation of the secured system, such as unlocking or opening an access door to the control room, unscheduled communications, communications from an unknown, unauthorized or new source such as a phone, movement of the operator out the control chair or area, changes in system settings, power or communication interruptions or any other preset criteria for a specific system with its unique circumstances, procedures, controls and operation.

If the query by the on-site/on-board system for the audio key is not satisfied because either the audio key or the voice providing it is not recognized, the on-site/on-board system invokes protocols which take a variety of actions, such as blocking all input from controls of the person or persons failing to provide the correct audio key, notifying external personnel, passing control of the system to personnel and systems outside the control area, among others. The particular response given by the security system depends on the nature, capabilities and use of the secured system. A secured ship or a train, for example, might have a protocol which takes one or more of these actions after removing control from a control point which has failed a reauthorization query: restrict or shut off its power; freeze its steering; deploy its brakes or anchors; transmit control from those on-board to another control point.

### THE PREFERRED EMBODIMENT

In the preferred embodiment, the security system comprises a programmable voice/audio recognition system that uses spoken audio keys generated by authorized personnel before each use or access to the secured systems, such as equipment, machinery, weapons, power plants, refineries, pipelines or storage facilities, transportation units, among others. Access to the secured system is limited to authorized operators based on identification of them by responsible authorities at the audio key input station. Where practical, this input to the security system occurs in a secure location such as a ready-room which is itself is within a secure perimeter and remote from the controls being secured and is only available to personnel who have met additional traditional identification and authorizing criteria for access to secured sites.

The individual, unique audio keys are created by the authorized personnel and known only to them. The security system is configured to make specific responses to the various audio keys which might indicate an “all-is-well” audio key as well as audio keys indicating different levels of emergency, from personal health emergencies, to attempted sabotage, or such other coded messages as may be configured into the system protocols. According to its pre-set instructions, the security system periodically and randomly queries the authorized personnel for the “all-is-well” audio keys they have spoken into the system earlier, and initiates queries when specific events occur, such as changes in the controls, unlocking or opening the access door to the control room, loud noises, power interruptions, among others events unique to the equipment being secured. The system may be configured to accept the particular audio keys for a specified time period such as through a normal shift period or until specific events occur such as an emergency requiring additional personnel beyond the initially authorized personnel or personnel with skills, knowledge and capabilities needed to meet the particular emergency. Obviously, the security system can be configured to require audio keys which signal a variety of circumstances, conditions and emergencies. It also can be configured to make a wide variety of responses.

If the on-board security system does not recognize the voice and audio key provided in response to a query, then the security system follows its pre-set instructions by which it may automatically remove control of secured system from the unrecognized personnel or even from the facility or control room where the unrecognized personnel is located, passing control to emergency or back-up personnel. These possible responses include the full range of actions which a computer system is capable such as engaging an automatic control system, shutting down power supplies, freezing controls, passing control to an emergency system, engaging monitoring systems, cameras, recorders, “black-boxes,” safety systems, control limits as well as notification to appropriate responsible personnel and emergency services, as well as more aggressive responses.

For weapons systems in law enforcement or combat situations where one or more personnel may be required to operate the secured equipment or where periodically voiced audio keys may not be practical, the security system may be configured to allow access to the secured equipment for extended periods following reauthorization extending until a disabling event such as a specified amount of transport or movement of the equipment has occurred, after specific motions or specific events such a set number of uses of the weapon, changing any of the user-controlled parameters of the weapon or weapon system, immersing, dropping the weapon or other loss of physical contact between the weapon and the authorized user, among others

The security system may be configured with appropriate verification procedures, to respond to external communications from appropriate remote authorities and from the authorized personnel on-board to reset the security system, returning control to the previously rejected personnel according to the protocols configured into the security system, such as requiring via their personnel “re-set” audio keys, verification by both remote and on-board personnel working with the unrecognized personnel as well as a recognized “re-set” audio key from the previously unrecognized personnel.

The security system has an active, read only memory such that any interruption in power to or tampering with the memory of the security system disables both the security system and the system being secured.

What I claim as an invention is:

1. A security system comprising:
(a) equipment with means to be controlled by at least one operator;
(b) an input station separate from the equipment being secured; and
(c) a second station located with the operator controlling the equipment being secured.

2. The security system according to claim 1 wherein the equipment being secured is selected from the group consisting of (i) mobile equipment, (ii) transportation equipment, (iii) portable equipment capable of being transported by at least one individual, and (iv) immobile, fixed installations.

3. The input station of the security system according to claim 2 having means to receive audio information provided orally by the operator;
(a) the input station having means to receive biometric information provided by the operator;
(b) the input station having means to send signals to the operator, indicating when the input station is prepared to receive information from the operator;
(c) the input station having means to receive information from the operator in response to each signal; and
(d) the input station further having means to record information received from the operator.

4. The input station of the security system according to claim 3 having means to be adjusted by at least one security system manager wherein (a) the number and content of the signals sent to the operator providing the information can be altered; (b) the input station further having means to receive and record instructions from the security system manager for each signal sent to the operator; (c) the input station further having means to communicate via a closed link to the second system located with the secured equipment, the number and content of the signals, the responses of the operator to each signal and the instructions provided by the manager for each signal; and (d) the input station further having means to receive and record additional instructions from the security manager for the timing, frequency, and conditions for operation of the second station as well as instructions for setting confidence levels for the information recorded from the operator.

5. The second station according to claim 1 having means to receive and record instructions directly from the security system manager for verifying information received from the input station; having means to apply the verifying instructions; and the means to receive, record and retrieve information conforming to these instructions.

6. The second station according to claim 5 having means to receive audio information provided orally by the operator;
(a) the second station having means to receive biometric information provided by the operator;
(b) the second station having means to send a signal to the operator, indicating the second station is requiring information from the operator;
(c) the second station further having means to send with the signal to the operator the information being required from the operator by the security system; and
(c) the second station having means to record information received from the operator in response to the signal.

7. The second station according to claim 6 having means to select according to the operational instructions provided by the manager, one of the signals at a time, means to send the selected signal to the operator, means to receive and to record information provided by the operator in response to the signal.

8. The second station according to claim 7 having means of comparing the original information generated by the operator at the input station with information provided in response to the request initiated by the second station.

9. The second station according to claim 8 having means to implement, based on the results of the comparison, the instructions provided by the security system manager for the signal selected.

10. The second station according to claim 9 having means to send reports of its results and instructions implemented to the security system manager and others according to operational instructions;
(a) means to receive and record additional operational instructions when it is not in closed communications with the input station;
(b) means to verify the validity of additional instructions according procedures established by the initial instructions;
(c) means to compare these additional operational instructions with the initial operational instructions included with the information provided by the operator;
(d) means to implement and report to the security system manager the results of comparing these instructions and subsequent actions taken; and
(e) means to report to the system security manager and others as required by the operational instructions, the status of the security system and status of the equipment being secured.
